(19) United States
(12) Patent Application Publication
(10) Pub. No.: US 2015/0317185 A1
(43) Pub. Date: Nov. 5, 2015

(54) METHOD FOR SWITCHING OPERATING SYSTEM AND ELECTRONIC DEVICE USING THE METHOD

(71) Applicant: PEGATRON CORPORATION, TAIPEI CITY (TW)

(72) Inventors: Chao-Yen Wu, TAIPEI CITY (TW); Tzu-Yu Yeh, TAIPEI CITY (TW)

(21) Appl. No.: 14/668,386

(22) Filed: Mar. 25, 2015

(30) Foreign Application Priority Data
May 5, 2014 (TW) 103115978

(51) Int. Cl. G06F 9/48

(52) U.S. Cl. CPC G06F 9/4806

(57) ABSTRACT

A method for switching an operating system suitable for an electronic device is disclosed. The electronic device is capable of running a first operating system and a second operating system. The user interface of the first operating system is displayed at a display unit of the electronic device, including information of at least one application program of the second operating system. When the information of the application program on the user interface of the first operating system is selected, the electronic device wakes up the second operating system and switches to display the user interface of the second operating system to execute the application program. Moreover, an electronic device using this method is also disclosed.

### CROSS-REFERENCE TO RELATED APPLICATION

This application claims the priority benefit of Taiwan application serial no. 103115978, filed on May 5, 2014. The entirety of the above-mentioned patent application is hereby incorporated by reference herein and made a part of this specification.

### BACKGROUND OF THE INVENTION

1. Field of Invention

The invention relates to a method of using multiple operating systems and, in particular, to a method for switching between operating systems and an electronic device using the method.

2. Related Art

Along with the progress of technology, it is necessary for electronic devices available on the market to have multiple functions to satisfy the user needs. Depending on different needs, multiple operating systems may be installed on the same electronic device. For example, the Android and the Microsoft Windows operating systems may be installed on the same tablet PC.

Generally speaking, when a user wants to execute an Android application program under the Microsoft Windows operating system, it is required to switch to the Android operating system first and then select the application program. This makes the switch of the two operating systems and the steps of executing the application program more complicated. Another design of an electronic device installed with dual operating systems is to use two processing units, such as two CPUs (central processing units), and two sets of corresponding hardware systems to run the Android operating system and the Microsoft Windows operating system respectively, and to achieve the objective of switching between operating systems by switching hardware and the screen image displayed. With this design, the electronic device needs to have multiple processing units and corresponding hardware systems, which increases the manufacturing costs and the power consumptions.

### SUMMARY OF THE INVENTION

The invention provides a method for switching an operating system and an electronic device using this method, which make the switch of the operating system and the execution of the application program more convenient.

The method for switching an operating system of the invention is suitable for an electronic device. The electronic device is capable of running a first operating system and a second operating system. The user interface of the first operating system is displayed at a display unit of the electronic device, including information of at least one application program of the second operating system. When the information of the application program on the user interface of the first operating system is selected, the electronic device wakes up the second operating system and switches to display the user interface of the second operating system to execute the application program at the display unit of the electronic device.

In one embodiment of the invention, the information of the application program includes the icon and the name of the application program.

In one embodiment of the invention, the method for switching the operating system further includes the following step. When the information of the application program is selected, the electronic device makes the first operating system enter into a sleeping state.

In one embodiment of the invention, the method for switching the operating system further includes the following steps. When displaying the information of the application program on the user interface of the first operating system, a switch option is displayed at the user interface of the first operating system. When the switch option is selected, the electronic device wakes up the second operating system and switches to display the user interface of the second operating system without executing the application program.

In one embodiment of the invention, the method for switching the operating system further includes the following steps. A shared data storage area is provided at the electronic device, wherein the shared data storage area is suitable for the first operating system and the second operating system. The information of the application program is stored in the shared data storage area. The first operating system reads the information of the application program from the shared data storage area.

In one embodiment of the invention, the method for switching the operating system further includes the following step. When the number or type of the application program is changed, the second operating system updates the information in the shared data storage area according to the application program.

In one embodiment of the invention, the method for switching the operating system further includes the following steps. When the information of the application program on the user interface of the first operating system is selected, an instruction corresponding to the application program is stored in the shared data storage area. The second operating program executes the application program according to the instruction.

In one embodiment of the invention, the electronic device runs the first operating system by a processing unit, and the step of waking up the second operating system includes the following step. The second operating system is run by the processing unit.

The electronic device of the invention is capable of running a first operating system and a second operating system simultaneously and includes a display unit and an operating unit. The display unit is suitable for displaying the user interface of the first operating system, including information of at least one application program of the second operating system. When the information of the application program on the user interface of the first operating system is selected, the electronic device wakes up the second operating system and switches to display the user interface of the second operating system to execute the application program by the operating unit.

In one embodiment of the invention, the information of the application program comprises the icon and the name of the application program.

In one embodiment of the invention, when the information of the application program on the user interface of the first operating system is selected, the electronic device makes the first operating system enter into a sleeping state by the operating unit.

In one embodiment of the invention, when the display unit displays the information of the application program on the user interface of the first operating system, a switch option is displayed on the user interface of the first operating system, when the switch option is selected, the electronic device wakes up the second operating device by the operating unit and switches to display the user interface of the second operating system without executing the application program.

In one embodiment of the invention, the electronic device further includes a storage unit, wherein the storage unit has a shared data storage area, the shared data storage area is suitable for the first operating system and the second operating system, the information of the application program is stored in the shared data storage area, and the first operating system reads the information of the application from the shared data storage area.

In one embodiment of the invention, when the number or type of the application program is changed, the second operating system updates the information in the shared data storage area according to the application program.

In one embodiment of the invention, when the information of the application program on the user interface of the first operating system is selected, an instruction corresponding to the application program is stored in the shared data storage area, and the second operating system executes the application program according to the instruction.

In one embodiment of the invention, the electronic device further includes a processing unit, wherein the electronic device runs the first operating system by the processing unit, and the electronic device runs the second operating system by the processing unit.

Based on the above, the electronic device of the invention can display the information of the application program of the second operating system on the user interface of the first operating system. When the user wants to execute the application program of the second operating system under the first operating system, the information of the application program can be selected directly on the user interface of the first operating system. The electronic device can switch to the second operating system and execute the application program automatically, and it is not necessary to switch to the second operating system first and then select the application program. Therefore, the switch of the two operating systems and the execution of the application program are simplified to enhance the convenience of the switch and operation of the two operating systems of the electronic device.

The invention will become more fully understood from the detailed description and accompanying drawings, which are given for illustration only, and thus are not limitative of the present invention

### BRIEF DESCRIPTION OF THE DRAWINGS

FIG. 1 is a block diagram of the electronic device of an embodiment of the invention.

FIG. 2 is a flowchart of the method for switching the operating system according to an embodiment of the invention.

FIG. 3 depicts the window of the first operating system displayed on the display unit of FIG. 2.

### DETAILED DESCRIPTION OF THE EMBODIMENT

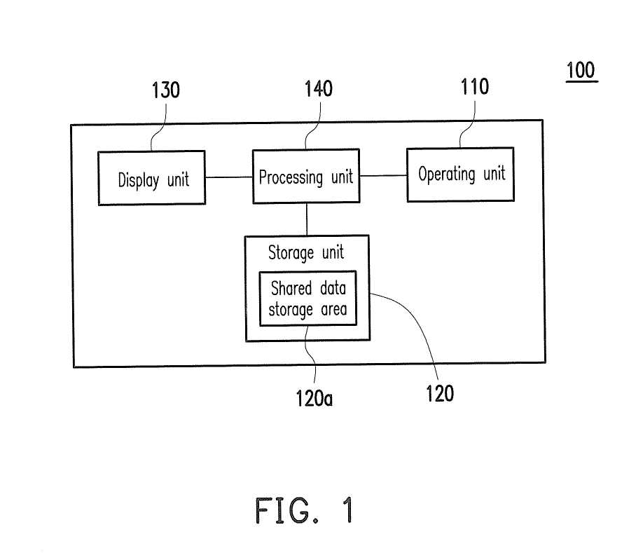

FIG. 1 is a block diagram of the electronic device of an embodiment of the invention. Referring to FIG. 1, the electronic device 100 of the embodiment is, for example, a tablet PC, and includes an operating unit 110, a storage unit 120, a display unit 130 and a processing unit 140. The operating unit 110, the storage unit 120 and the display unit 130 are, for example, the BIOS (basic input output system), the hard drive and the display interface of the tablet PC, respectively. The processing unit 110 is, for example, the CPU (central processing unit) of the tablet PC, and is coupled to the operating unit 120, the storage unit 130 and the display unit 140.

The electronic device 100 can run a first operating system and a second operating system simultaneously, which are for example installed on two partitions of the storage unit 130, respectively. The first operating system and the second operating system in this embodiment are the Microsoft Windows operating system and the Android operating system, respectively, while the invention is not limited thereto. In other embodiments, the first operating system and the second operating system may be other operating systems. The method for switching between the operating system of the electronic device 100 will be described below.

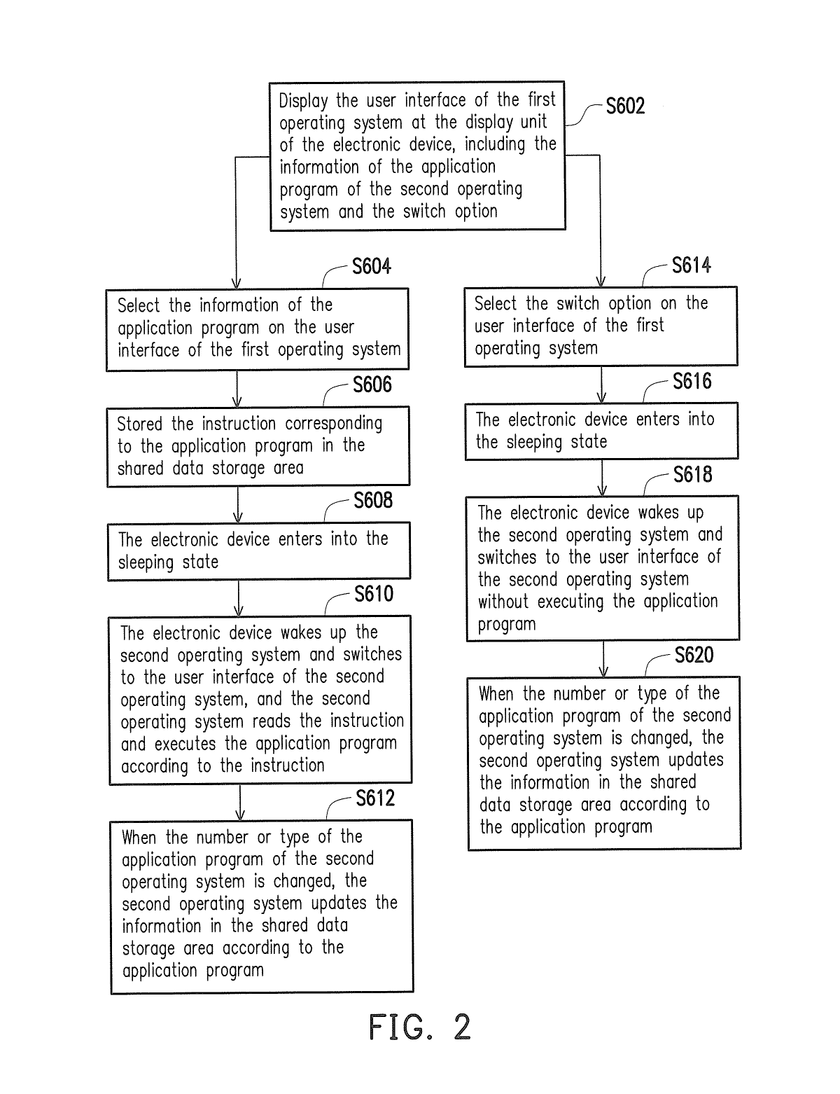

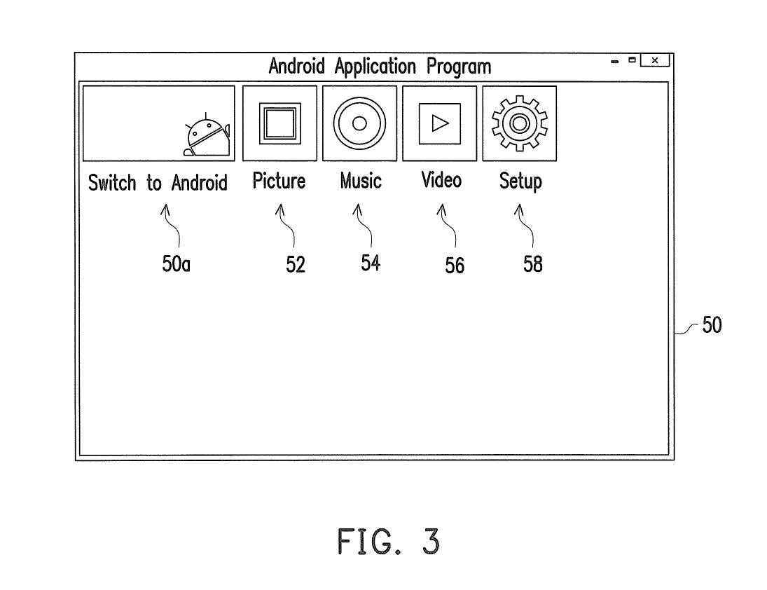

FIG. 2 is a flowchart of the method for switching the operating system according to an embodiment of the invention. FIG. 3 depicts the window of the first operating system displayed on the display unit of FIG. 2. Please refer to FIG. 1 to FIG. 3. First, after the first operating system is loaded by the operating unit 110 of the electronic device 100, the user interface of the first operating system, including the information of the application program of the second operating system, is displayed on the display unit 130 of the electronic device 100 (step S602). The information may include the icon and name of the application program. For example, the information may be, for example, the information 52, the information 54, the information 56 and the information 58 of the window 50, which correspond to several application programs of the second operating system, respectively. FIG. 3 depicts these application programs of the second operating system as picture application program, music application program, video application program and setup application program. However, other application program may be available in other embodiments, and the invention is not limited thereto. Moreover, the second operating system is the Android operating system in FIG. 3, but this is just for exemplary purpose without limiting sense.

Afterward, when the user selects the information of the application program on the user interface of the first operation system (step S604), the electronic device 100 wakes up the second operating system and switches to display the user interface of the second operating system and execute the application program (step S610). Specifically, the user can select one of the information 52, the information 54, the information 56 and the information 58 shown in FIG. 3. When this happens, the electronic device 100 wakes up and switches to the second operating system by the operating unit 110, and displays the user interface of the second operating system on the display unit 130 so as to execute the application program corresponding to the information 52, the information 54, the information 56 or the information 58.

With the operations above, when the user wants to execute the application program of the second operating system under the first operating system, the user can select the information of the application program on the user interface of the first operating system directly to switch the electronic device 100 to the second operating system and execute the application program automatically. It is not necessary to switch the second operation system and then select the application program. Accordingly, the switching between two operating systems and the execution of the application program are simplified, and the convenience of the operation of the electronic device 100 having two operation systems is enhanced.

When the electronic device 100 displays the information of the application program by the display unit 130 in step S602 mentioned above, the display unit 130 may further display a switch option 50a in the window 50 except for the information 52, the information 54, the information 56 and the information 58. The switch option 50a may include an icon of the second operating system and a prompt about switching to the second operating system, as shown in FIG. 3. When the user selects the switch option 50a on the user interface of the first operating system (step S614), the electronic device 100 wakes up the second operating system via the operating unit 110 and switches to display the user interface of the second operating system without executing the application program corresponding to the information 52, the information 54, the information 56 or the information 58 (step S618). With this operation, the user can switch the operating system without executing the application program automatically.

In detail, when the user selects information of the application program on the user interface of the first operating system in step S604 mentioned above or selects the switch option on the user interface of the first operating system in step S614 mentioned above, the electronic device 100 makes the first operating system enter into a sleeping state via the operating unit 110 (step S608 or S616), and then wakes up the second operating system via the operating unit 110 (step S610 or S618). When the first operating system enters into the sleeping state, the parameters and data of the application program executed under the first operating system can be stored in the memory of the electronic device 100, so that the operation of the user can be resumed when the first operation system is waken up again later.

The electronic device 100 of the present embodiment uses the processing unit 140 to run the first operating system, and uses the same processing unit 140 to run the second operating system when the first operating system enters into the sleeping state and the second operating system wakes up as in step S610 or S618 mentioned above to achieve the objective of switching the operating system. Since the electronic device 100 switches the operating system by means of software rather than by hardware and the switch of the display screen, it is not necessary to run the first operating system and the second operating system by different processing units. Since only one processing unit 140 and corresponding hardware components are required, the manufacturing costs of the electronic device 100 are saved and the power consumptions of the electronic device 100 are lowered.

In the present embodiment, the storage unit 120 of the electronic device 100 has a shared data storage area 120a suitable for both the first operating system and the second operating system. For example, the shared data storage area 120a may be a partition of the storage unit 120 complying with FAT32 and suitable for the Microsoft Windows operating system and the Android operating system. The information 52, information 54, information 56 and the information 58 of the application programs of the second operating system shown in FIG. 3 are stored in the shared data storage area 120a, and the first operating system reads the information 52, information 54, information 56 and the information 58 of the application programs from the data storage area 120a to show them in the window 50 shown in FIG. 3 under the first operating system for the user to select.

Furthermore, when the information of the application program on the user interface of the first operating system is selected in step S604 mentioned above, an instruction corresponding to this application program is stored in the shared data storage area 120a (step S606). When the electronic device 100 wakes up the second operating system, the second operating system reads the instruction from the shared data storage area 120a and executes the corresponding application program corresponding according to the instruction (step S610). Moreover, when the number or type of the application program of the second operating system is changed, the second operating system updates the information in the shared data storage area 120a according to the application program (step S612 or S620). The update mentioned above can ensure that the information in the shared data storage area 120a correctly corresponds to the application program of the second operating system, so that the first operating system can read the correct information after being waken up again.

To sum up, the electronic device of the invention can display the information of the application program of the second operating system on the user interface of the first operating system. When the user wants to execute the application program of the second operating system under the first operating system, the information of the application program can be selected directly on the user interface of the first operating system. The electronic device can switch to the second operating system and execute the application program automatically, and it is not necessary to switch to the second operating system first and then select the application program. Therefore, the switch of the two operating systems and the execution of the application program are simplified to enhance the convenience of the switch and operation of the two operating systems of the electronic device. Moreover, since the electronic device switches the operating system by means of software rather than by hardware and the switch of the display screen, it is not necessary to run the first operating system and the second operating system by different processing units. Since only one processing unit and corresponding hardware components are required, the manufacturing costs of the electronic device are saved and the power consumptions of the electronic device are lowered.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for switching an operating system, suitable for an electronic device, the electronic device being capable of running a first operating system and a second operating system, the method comprising:
displaying an user interface of the first operating system at a display unit of the electronic device, the user interface including information of at least one application program of the second operating system; and
when the information of the application program on the user interface of the first operating system is selected, waking up the second operating system and switching to display an user interface of the second operating system to execute the application program at the display unit of the electronic device.

2. The method for switching an operating system according to claim 1, wherein the information of the application program comprises the icon and the name of the application program.

3. The method for switching an operating system according to claim 1, further comprising:
when the information of the application program is selected, the electronic device making the first operating system enter into a sleeping state.

4. The method for switching an operating system according to claim 1, further comprising:
when displaying the information of the application program on the user interface of the first operating system, displaying a switch option on the user interface of the first operating system; and
when the switch option is selected, the electronic device waking up the second operating system and switching to display the user interface of the second operating system without executing the application program.

5. The method for switching an operating system according to claim 1, further comprising:
providing a shared data storage area at the electronic device, wherein the shared data storage area is suitable for the first operating system and the second operating system;
storing the information of the application program in the shared data storage area; and
the first operating system reading the information of the application program from the shared data storage area.

6. The method for switching an operating system according to claim 5, further comprising:
when the number or type of the application program is changed, the second operating system updating the information in the shared data storage area according to the application program.

7. The method for switching an operating system according to claim 5, further comprising:
when the information of the application program on the user interface of the first operating system is selected, storing an instruction corresponding to the application program in the shared data storage area; and
the second operating program executing the application program according to the instruction.

8. The method for switching an operating system according to claim 1, wherein the electronic device runs the first operating system by a processing unit, and the step of waking up the second operating system comprises:
running the second operating system by the processing unit.

9. An electronic device capable of running a first operating system and a second operating system, comprising:
a display unit for displaying an user interface of the first operating system, the user interface including information of at least one application program of the second operating system; and
an operating unit, when the information of the application program on the user interface of the first operating system is selected, the electronic device waking up the second operating system and switching to display an user interface of the second operating system to execute the application program by the operating unit.

10. The electronic device according to claim 9, wherein the information of the application program comprises the icon and the name of the application program.

11. The electronic device according to claim 9, wherein when the information of the application program on the user interface of the first operating system is selected, the electronic device makes the first operating system enter into a sleeping state by the operating unit.

12. The electronic device according to claim 9, wherein when the display unit displays the information of the application program on the user interface of the first operating system, a switch option is displayed on the user interface of the first operating system, when the switch option is selected, the electronic device wakes up the second operating device by the operating unit and switches to display the user interface of the second operating system without executing the application program.

13. The electronic device according to claim 9, further comprising a storage unit, wherein the storage unit has a shared data storage area, the shared data storage area is suitable for the first operating system and the second operating system, the information of the application program is stored in the shared data storage area, and the first operating system reads the information of the application from the shared data storage area.

14. The electronic device according to claim 13, wherein when the number or type of the application program is changed, the second operating system updates the information in the shared data storage area according to the application program.

15. The electronic device according to claim 13, wherein when the information of the application program on the user interface of the first operating system is selected, an instruction corresponding to the application program is stored in the shared data storage area, and the second operating system executes the application program according to the instruction.

16. The electronic device according to claim 9, further comprising a processing unit, wherein the electronic device runs the first operating system by the processing unit, and the electronic device runs the second operating system by the processing unit.
